(19) United States
(12) Patent Application Publication
(10) Pub. No.: US 2026/0009434 A1
(43) Pub. Date: Jan. 8, 2026

(54) HYDRODYNAMIC RETARDER

(71) Applicant: Voith Patent GmbH, Heidenheim (DE)

(72) Inventors: Dieter Laukemann, Frankenhardt (DE); Alexander Martin, Kressberg (DE); Martin Blumenstock, Frankenhardt (DE)

(73) Assignee: Voith Patent GmbH, Heidenheim (DE)

(21) Appl. No.: 19/324,389

(22) Filed: Sep. 10, 2025

Related U.S. Application Data
(63) Continuation of application No. PCT/EP2024/056125, filed on Mar. 8, 2024.

(30) Foreign Application Priority Data
Mar. 10, 2023 (DE) 10 2023 105 954.8

(51) Int. Cl. F16D 57/04

(52) U.S. Cl. CPC F16D 57/04

(57) ABSTRACT

A hydrodynamic retarder includes: a retarder chamber in which a rotor and a stator are arranged, the rotor and the stator together forming a working chamber that is for being filled with and emptied of a working medium; a working medium tank, which includes a sump, storage, and expansion regions, the sump and storage regions for accommodating the working medium that is not currently in the working chamber; a filling channel for supplying the working medium into the working chamber; a return channel for discharging the working medium from the working chamber; a rotor housing; a stator housing; a tank housing, the rotor housing and the tank housing forming the working medium tank, the retarder chamber being a space that is enclosed by the rotor housing and the stator housing; and a first coupling level, which is arranged between the rotor housing and the stator housing within working medium tank.

### CROSS REFERENCE TO RELATED APPLICATIONS

This is a continuation of PCT application no. PCT/EP2024/056125, entitled “HYDRODYNAMIC RETARDER”, filed Mar. 8, 2024, which is incorporated herein by reference. PCT application no. PCT/EP2024/056125 claims priority to German patent application no. 10 1023 105 954.8, filed Mar. 10, 2023, which is incorporated herein by reference.

### BACKGROUND OF THE INVENTION

### 1. Field of the Invention

The present invention relates to hydrodynamic retarders.

### 2. Description of the Related Art

Hydrodynamic retarders include a working chamber that can be filled with and emptied of working medium. A torque is transferred from a bladed rotor to a bladed stator with the assistance of the working medium. When the working chamber is filled, the rotor and thus a shaft that is designed to rotate with the rotor, for example a drive shaft or transmission output shaft that is indirectly connected to the wheels of a vehicle, is decelerated.

The general structure of a retarder is standard technology and is known, for example from DE 10 2017 109 014 A1. Here, a structural unit is proposed including a rotor mounted on a shaft, which is rotatably mounted relative to the unit on both sides of the rotor. The unit includes a rotor housing, a stator housing, and a bearing housing. The unit, also referred to as a rotating component, is designed to be accommodated into a housing.

A similar rotating component or structural unit is known from DE 10 2012 002 038 A1, which is pre-assembled and inserted into a housing component. The housing component, together with a second housing component, forms a working medium tank. The working medium tank is connected by way of several channels with the retarder working chamber between the rotor and the stator. The housing components include sections of channels for conveying the working medium, whereby the channels are only formed after assembly of the components. The channels usually do not have closed walls, so that additional components and seals are provided to form the actual channels. Furthermore, there are several large sealing areas between the components that must be sealed against the environment. When oil is used as the working medium, it is important that no oil can escape into the environment. The manufacturing effort for retarders manufactured in this way with a working medium tank is correspondingly complex and cost-intensive.

What is needed in the art is a retarder with reduced manufacturing and assembly costs.

### SUMMARY OF THE INVENTION

The invention relates to the structure of a hydrodynamic retarder for a motor vehicle, in particular to the structure of the working medium tank of the retarder.

The present invention provides a hydrodynamic retarder including a retarder chamber in which a rotatably mounted rotor and a stator are arranged, which together form a working chamber that can be filled with and emptied of working medium. The retarder also includes a working medium tank which has a region to accommodate working medium that is not currently in the working chamber, and an expansion region, at least one filling channel for feeding working medium into the working chamber and a return channel for discharging working medium from the working chamber, as well as a rotor housing, a stator housing, and a tank housing.

The present invention provides that the rotor housing and the tank housing form the working medium tank and that the retarder chamber is a space that is enclosed by the rotor housing and the stator housing, wherein a coupling level is arranged between the rotor housing and the stator housing within the working medium tank. In terms of the present invention, this means that, in particular the rotor, the stator as wells as the filling channel and the return channel are located within the space formed by the rotor housing and the tank housing.

In one optional design, the retarder chamber can be a space that is formed by the rotor housing and a stator housing, wherein the stator is located between the rotor housing and the stator housing. The stator housing is thereby arranged entirely within the space formed by the rotor housing and the tank housing. The rotor, which is arranged on a rotor shaft is optionally supported by a first bearing opposite the rotor housing and a second bearing opposite the stator or the stator housing.

The internal contact surfaces, for example the surfaces between the rotor housing, stator and stator housing, can form functional levels, wherein no seal is required in the functional level. In the event of a minor leak in the functional level, the working medium returns directly to the working medium tank.

This design separates the actual retarder function from the sealing function against the environment, and only one large-surface seal is required, with no further functions having to be secured via the seal arranged between the components.

It may also be provided that the rotor housing and the tank housing are shell-shaped and that a seal is arranged between rotor housing and tank housing. The sealing surfaces on the rotor housing and tank housing are easy to manufacture, so that a reliable seal of the working medium tank against the environment can be provided.

Moreover, a coupling level can be provided on the tank housing, which includes a first channel and a second channel, by way of which a fluid-conducting connection to the primary side of a heat exchanger can be established. This coupling level can also be easily sealed. An intermediate component with intermediate channels can be arranged between heat exchanger and tank housing. The channels can be provided alternatively at different coupling levels on the tank housing.

It is also proposed that the return channel is designed as a fluid-conducting connection between working chamber and supply channel, whereby the return channel can be integrated, at least in sections, into the stator housing. Alternatively, a pipeline connection could be provided.

Moreover, an inlet chamber can be arranged between filling channel and working chamber, wherein the inlet chamber is a space that is formed between the stator and stator housing components.

In the optional design, the working medium tank has an expansion region, a storage region and a sump region, wherein the filling channel is designed as a pipeline which runs essentially through the working medium tank and wherein an inlet opening of the filling channel terminates in the sump region. This prevents air from entering into the working chamber via the filling channel when the retarder is switched into braking mode.

The inlet opening into the filling channel and an outlet opening of the return channel are optionally aligned with each other. It is thereby advantageous if the distance (x) between inlet opening and outlet opening is between 1 mm and 25 mm.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 is a sectional sketch of a retarder.

Corresponding reference characters indicate corresponding parts throughout the several views. The exemplification set out herein illustrates at least one embodiment of the invention, and such exemplification is not to be construed as limiting the scope of the invention in any manner.

### DETAILED DESCRIPTION OF THE INVENTION

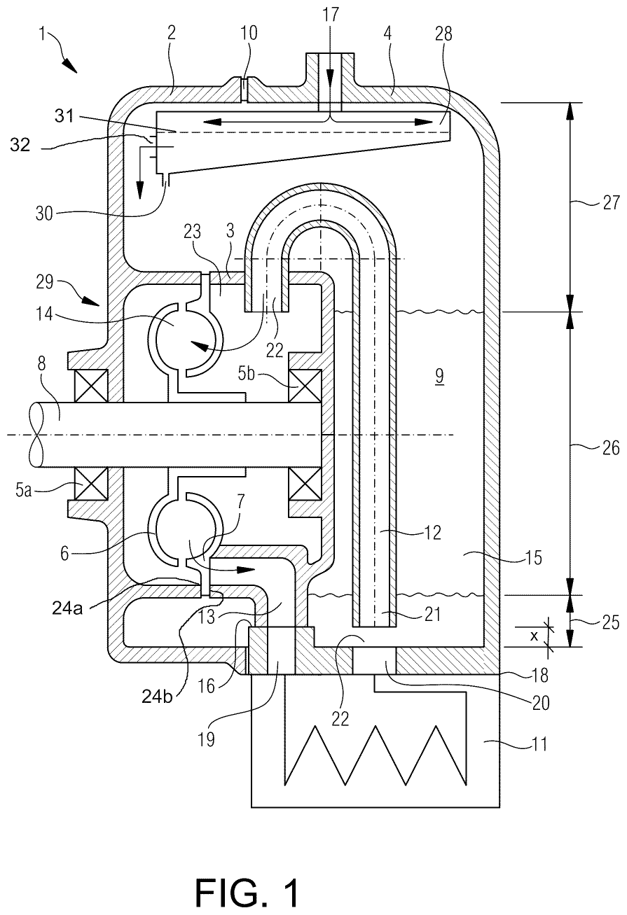

The sketch in FIG. 1 illustrates the basic housing structure of retarder 1. The outer enclosure of retarder 1 consists essentially of two parts: rotor housing 2 and stator housing 3, each of which forms a half-shell of the housing. Housing parts 2 and 3 enclose a cavity, which is divided into three regions. Cavity region 27, storage region 26, and retarder region 29 are provided.

Together, cavity region 27, storage region 26, and retarder region 29 form working medium tank 15, wherein working medium 9 accumulates in storage region 26 and sump region 25 when the retarder is switched to non-braking mode.

Cavity region 27 is a space, designed essentially to ensure that no working medium can get into the compressed air control—also referred to as MRCU—via connection 17. A working medium separator or oil separator 28 is provided between connection 17 and working medium tank 15. Separated oil can flow back into working medium tank 15 via outlet 30.

During braking operation, the compressed air control regulates the braking torque of retarder 1. The higher the air pressure in cavity region 27, the more working medium 9 is forced from working medium tank 15 into the retarder circuit.

The region between rotor housing 2 and stator housing 3 is referred to as retarder chamber 29. Rotor 6, stator 7, bearing-mounted rotor shaft 8, and channels for conveying the working medium are located in retarder chamber 29. As is known from the current state of the art, rotor 6 can be arranged axially movable on rotor shaft 8.

Rotor shaft 8, on which rotor 6 is mounted in a rotationally fixed manner, is supported, as shown in FIG. 1, by a first bearing 5a opposite the rotor housing and by a second bearing 5b opposite stator housing 3. Another solution which is not shown is to support it opposite stator 7. In this solution, a bearing ring is provided on stator 7, in which the outer ring of bearing 5b is accommodated, so that there is only one coupling point relative to the rotor housing.

A coupling level 18 is provided on tank housing 4, to which heat exchanger 11 can be attached directly or indirectly, wherein first channel 19 and second channel 20 are provided in coupling level 18. Via first channel 19, working chamber 14 is connected between rotor 6 and stator 7 to the flow connection of heat exchanger 11, and the outlet of heat exchanger 11 is connected to working medium tank 15 via second channel 20. Cooled working medium 9 enters working medium tank 15 via second channel 20 when switching to non-braking mode, in other words, when the pressure in expansion region 27 drops.

Moreover, a filling channel 12 is provided, which establishes a connection from lower sump region 25 into inlet chamber 23, which in turn is connected to working chamber 14 via channels in stator 7, not shown.

When switching the retarder into braking mode, the air pressure in expansion region 27 is increased via connection 17, as a result of which working medium 9 enters working chamber 14 via filling channel 12, inlet chamber 23, and the channels in stator 7. The known pumping action of retarder 1 causes working medium 9 to be pumped back from the working chamber via return channel 13, first channel 19, heat exchanger 11, and second channel 20 into working medium tank 15.

Filling channel 12 is arranged relative to second channel 20 in such a way that working medium 9 flowing out of second channel 20 can flow via inlet opening 21 into filling channel 12. In braking mode, this creates a circular flow, whereby working medium 9 flows over a short section through working medium tank 15. The distance between the outlet of second channel 20 and inlet opening 21 can be selected between 1 mm and 25 mm, wherein mixing of working medium 9 from the tank and working medium 9 from the circuit depends on the distance. Also, the minimum working medium level in working medium tank 15 must be above inlet opening 21 to ensure that no air enters into filling channel 12.

The pressure of the control air in expansion region 27 regulates the working medium volume in the circuit, which in turn determines the braking torque of the retarder. This control of the braking torque is standard technology and is therefore not discussed in further detail.

The housing structure of retarder 1 is significant for this invention, wherein the surfaces of functional levels 16, 24a, 24b are not at the same time the sealing surfaces against the environment. Functional levels 16, 24a, 24b are levels that are crucial for the function of the retarder.

Opposite surfaces of functional levels 16, 24a, 24b are subject to tight tolerances. Adherence to tolerances is significantly simplified if minor leaks due to the omission of a seal have no relevance.

All functional levels 16, 24a, 24b are located within retarder housing components 2 and 4, so that oil escaping from retarder chamber 29 flows directly back into working medium tank 15. Rotor housing 2 and tank housing 4 are sealed off from the environment by way of seal 10, wherein components 2 and 4 only interact with each other and have no influence on the retarder function.

As an alternative to the illustrated sealing arrangement for working chamber 14, two O-rings 34 can be provided instead of seal 10, with one O-ring sealing radially and one O-ring sealing axially. The tolerance requirements for such a design would be significantly lower.

### COMPONENT REFERENCE LISTING

1 Retarder
2 Rotor housing
3 Stator housing
4 Tank housing
5a, b Bearing
6 Rotor
7 Stator
8 Rotor shaft
9 Working medium
10 Seal
11 Heat exchanger
12 Filling channel
13 Return channel
14 Working chamber
15 Working medium tank
16 Coupling level
17 Connection
18 Connecting level
19 First channel
20 Second channel
21 Inlet opening
22 Outlet opening
23 Inlet chamber
24a, b Coupling level
25 Sump region
26 Storage region
27 Expansion region
28 Oil separator
29 Retarder chamber
30 Outlet
31 Structure element
32 Air passage
X Distance

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hydrodynamic retarder, comprising:
a stator;
a rotor, which is rotatably mounted;
a retarder chamber in which the rotor and the stator are arranged, the rotor and the stator together forming a working chamber that is configured for being filled with and emptied of a working medium;
a working medium tank, which includes a sump region, a storage region, and an expansion region, the sump region and the storage region being configured for accommodating the working medium that is not currently in the working chamber;
at least one filling channel configured for supplying the working medium into the working chamber;
a return channel configured for discharging the working medium from the working chamber;
a rotor housing;
a stator housing;
a tank housing, the rotor housing and the tank housing forming the working medium tank, the retarder chamber being a space that is enclosed by the rotor housing and the stator housing; and
a first coupling level, which is arranged between the rotor housing and the stator housing within working medium tank.

2. The hydrodynamic retarder according to claim 1, further including a seal, wherein the rotor housing and the tank housing are shell-shaped, the seal being arranged between the rotor housing and the tank housing.

3. The hydrodynamic retarder according to claim 1, wherein the retarder chamber is the space, the space being formed by the rotor housing and the stator housing, the stator being arranged between the rotor housing and the stator housing.

4. The hydrodynamic retarder according to claim 3, further including a rotor shaft, a first bearing, and a second bearing, the rotor being mounted on the rotor shaft, the rotor shaft being supported by the first bearing opposite the rotor housing and by the second bearing opposite the stator housing.

5. The hydrodynamic retarder according to claim 1, further including a second coupling level on the tank housing, the second coupling level including a first channel and a second channel, wherein the hydrodynamic retarder further includes a heat exchanger and a fluid-connecting connection, the heat exchanger including a primary side, the first channel and the second channel establishing the fluid-conducting connection with the primary side of the heat exchanger.

6. The hydrodynamic retarder according to claim 1, further including a seal, wherein the rotor housing and the tank housing are shell-shaped, the seal being arranged between the rotor housing and the tank housing, the hydrodynamic retarder further including an inlet chamber, which is arranged between the at least one filling channel and the working chamber, wherein the inlet chamber is a space that is formed between the stator and the stator housing.

7. The hydrodynamic retarder according to claim 1, further including a seal, wherein the rotor housing and the tank housing are shell-shaped, the seal being arranged between the rotor housing and the tank housing, the hydrodynamic retarder further including an inlet chamber, which is arranged between the at least one filling channel and the working chamber, wherein the inlet chamber is a space that is formed between the stator and the stator housing.

8. The hydrodynamic retarder according to claim 1, wherein the at least one filling channel is configured as a pipeline which runs substantially through the working medium tank, wherein the at least one filling channel includes an inlet opening which terminates in the sump region.

9. The hydrodynamic retarder according to claim 1, further including a second coupling level on the tank housing, the second coupling level including a first channel and a second channel, wherein the hydrodynamic retarder further includes a heat exchanger and a fluid-connecting connection, the heat exchanger including a primary side, the first channel and the second channel establishing the fluid-conducting connection with the primary side of the heat exchanger, wherein the at least one filling channel includes an inlet opening, wherein the second channel is a return channel and includes an outlet opening, the inlet opening into the at least one filling channel and the outlet opening of the return channel being aligned with each other.

10. The hydrodynamic retarder according to claim 9, wherein a distance between the inlet opening and the outlet opening is between 1 mm and 25 mm.
